(19) United States
(12) Patent Application Publication
(10) Pub. No.: US 2024/0357534 A1
(43) Pub. Date: Oct. 24, 2024

(54) CONFIGURING DISASTER ASSISTANCE INFORMATION

(71) Applicant: Lenovo (Singapore) Pte. Ltd., New Tech Park (SG)

(72) Inventors: Genadi Velev, Darmstadt (DE); Dimitrios Karampatsis, Ruislip (GB); Apostolis Salkintzis, Athens (GR); Ishan Vaishnavi, München (DE)

(21) Appl. No.: 18/681,006

(22) PCT Filed: Sep. 9, 2021
(86) PCT No.: PCT/EP2021/074875

§ 371 Date: Feb. 2, 2024

(30) Foreign Application Priority Data
Aug. 4, 2021 (GR) 20210100529

(51) Int. Cl. H04W 60/00; H04W 4/90; H04W 48/18

(52) U.S. Cl. CPC H04W 60/00; H04W 4/90; H04W 48/18

(57) ABSTRACT

Apparatuses, methods, and systems are disclosed for configuring disaster assistance information. One method includes determining, at a first network function, the occurrence of a disaster condition. The method includes determining disaster detection assistance information, determining disaster roaming assistance information, or a combination thereof. The method includes transmitting a configuration message to a device. The configuration message includes: the disaster detection assistance information; the disaster roaming assistance information; or a combination thereof.

### FIELD

The subject matter disclosed herein relates generally to wireless communications and more particularly relates to configuring disaster assistance information.

### BACKGROUND

In certain wireless communications networks, disasters may impact cellular network services. A user equipment may be unable to communicate if the cellular network, where the user equipment is currently registered, is negatively impacted by a disaster.

### BRIEF SUMMARY

Methods for configuring disaster assistance information are disclosed. Apparatuses and systems also perform the functions of the methods. One embodiment of a method includes determining, at a first network function, the occurrence of a disaster condition. In some embodiments, the method includes determining disaster detection assistance information, determining disaster roaming assistance information, or a combination thereof. In certain embodiments, the method includes transmitting a configuration message to a device. The configuration message includes: the disaster detection assistance information; the disaster roaming assistance information; or a combination thereof.

One apparatus for configuring disaster assistance information includes a first network function. In some embodiments, the apparatus includes a processor that: determines the occurrence of a disaster condition; determines disaster detection assistance information, determines disaster roaming assistance information, or a combination thereof. In various embodiments, the apparatus includes a transmitter that transmits a configuration message to a device. The configuration message includes: the disaster detection assistance information; the disaster roaming assistance information; or a combination thereof.

Another embodiment of a method for configuring disaster assistance information includes receiving, at a device, a configuration message. The configuration message includes: disaster detection assistance information; disaster roaming assistance information; or a combination thereof. In some embodiments, the method includes determining to apply the configuration message in response to network coverage being lost and information contained in the configuration message being applicable.

Another apparatus for configuring disaster assistance information includes a device. In some embodiments, the apparatus includes a receiver that receives a configuration message. The configuration message includes: disaster detection assistance information; disaster roaming assistance information; or a combination thereof. In various embodiments, the apparatus includes a processor that determines to apply the configuration message in response to network coverage being lost and information contained in the configuration message being applicable.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring disaster assistance information;

FIG. 2 is a schematic block diagram illustrating one embodiment of an apparatus that may be used for configuring disaster assistance information;

FIG. 3 is a schematic block diagram illustrating one embodiment of an apparatus that may be used for configuring disaster assistance information;

FIG. 4 is a schematic block diagram illustrating one embodiment of a system

having a disaster condition;

FIG. 5 is a schematic block diagram illustrating one embodiment of a system for communicating to an AMF that a DisaC has occurred;

FIG. 6 is a schematic block diagram illustrating one embodiment of a system for communicating configuration a UE with disaster configuration information;

FIG. 7 is a flow chart diagram illustrating one embodiment of a method for a UE performing network selection;

FIG. 8 is a flow chart diagram illustrating one embodiment of a method for configuring disaster assistance information; and

FIG. 9 is a flow chart diagram illustrating another embodiment of a method for configuring disaster assistance information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the FIGS. illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

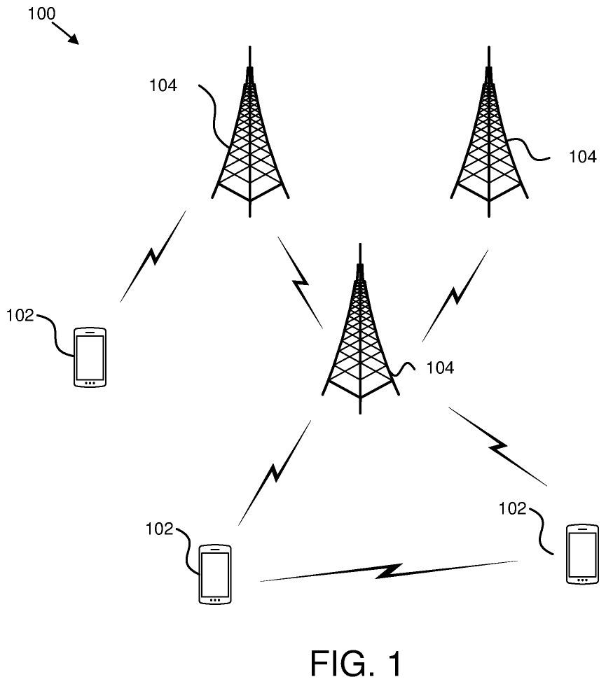

FIG. 1 depicts an embodiment of a wireless communication system 100 for configuring disaster assistance information. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are either part of a radio access network or part of the core network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a device, a configuration message. The configuration message includes: disaster detection assistance information; disaster roaming assistance information; or a combination thereof. In some embodiments, the remote unit 102 may determine to apply the configuration message in response to network coverage being lost and information contained in the configuration message being applicable. Accordingly, the remote unit 102 may be used for configuring disaster assistance information.

In certain embodiments, a network unit 104 may determine, at a first network function, the occurrence of a disaster condition. In some embodiments, the network unit 104 may determine disaster detection assistance information, determining disaster roaming assistance information, or a combination thereof. In certain embodiments, the network unit 104 may transmit a configuration message to a device. The configuration message includes: the disaster detection assistance information; the disaster roaming assistance information; or a combination thereof. Accordingly, the network unit 104 may be used for configuring disaster assistance information.

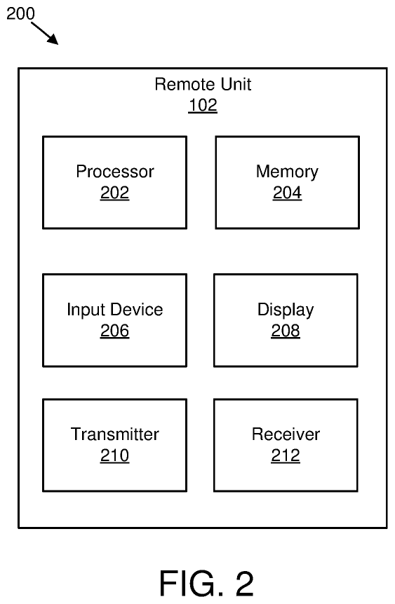

FIG. 2 depicts one embodiment of an apparatus 200 that may be used for configuring disaster assistance information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives a configuration message. The configuration message includes: disaster detection assistance information; disaster roaming assistance information; or a combination thereof. In various embodiments, the processor 202 determines to apply the configuration message in response to network coverage being lost and information contained in the configuration message being applicable.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

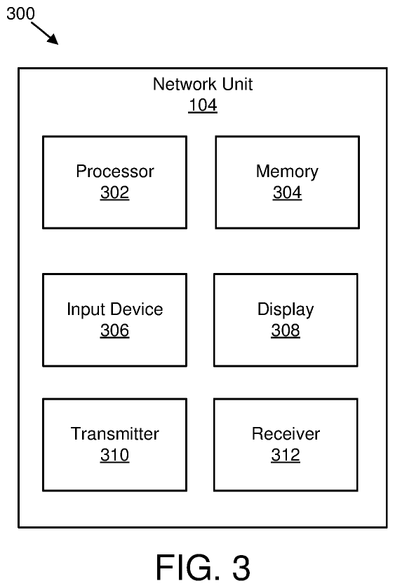

FIG. 3 depicts one embodiment of an apparatus 300 that may be used for configuring disaster assistance information. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302: determines the occurrence of a disaster condition; determines disaster detection assistance information, determines disaster roaming assistance information, or a combination thereof. In various embodiments, the transmitter 310 transmits a configuration message to a device. The configuration message includes: the disaster detection assistance information; the disaster roaming assistance information; or a combination thereof.

In certain embodiments, a fifth generation (“5G”) system (“5GS”) may have a high reliability and a high availability of communication service. Such embodiments may be available to any type of subscriber and may be available in conditions if a portion of the network is not available. In some embodiments, an access network (“AN”) (or a radio access network (“RAN”)) may have a single point of failure (e.g., antenna towers, single power, or single communication cable in a fronthaul or backhaul) so that due to extreme conditions (e.g., flooding, earthquake, fire, terror attack) one or more cells become unavailable. Such conditions may be called disaster conditions (“DisaC”).

In some embodiments, during disaster conditions some subscribers may be out of network coverage due to a failed AN. In such embodiments, to offer access to general public services, but also to specific vertical services, a subscriber may be able to use services of another network that is not in the list of preferred networks, or even a network that is in a list of forbidden networks. Moreover, in such embodiments, roaming to a visited network (e.g., visited (“V”) public land mobile network (“PLMN”) (“V-PLMN”)) may be called disaster roaming and may be required to be deployed by regulatory agencies.

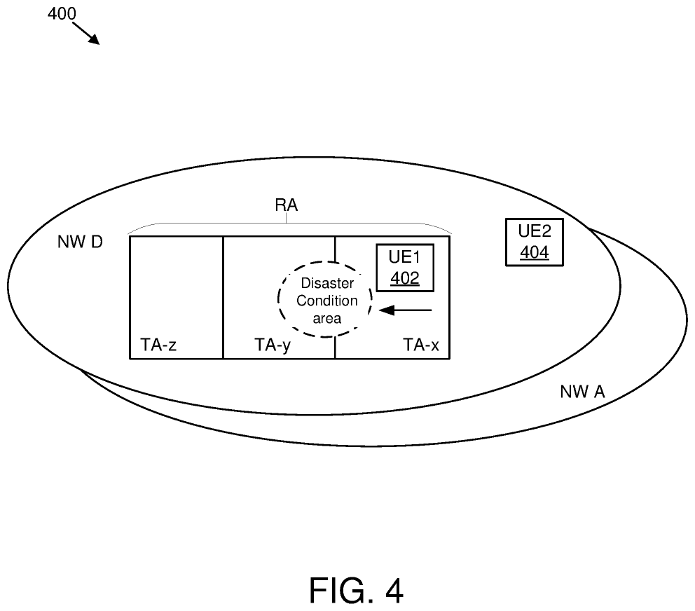

FIG. 4 is a schematic block diagram illustrating one embodiment of a system 400 having a disaster condition. The system 400 includes a first UE (UE1) 402 and a second UE (UE2) 404. In various embodiments, due to a disaster condition a part of a first network (network (“NW”) D) radio access network may not function. In such embodiments, the NW D (e.g., PLMN D) may be subject to disaster and a second network (NW A) (e.g., NW A or PLMN A) may be alive and may offer disaster roaming services to UEs from NW D. The NW A may provide disaster roaming services to the UE's from NW D which are in a disaster condition area. A DisaC area may involve one or more cells (e.g., served by one or more base stations). The disaster area may impact one or more tracking areas. In one example, two tracking areas (“TAs”) (e.g., TA-x and TA-y) may be impacted by a DisaC.

In certain embodiments, a user equipment (“UE”) (e.g., a first user equipment (UE1), a second user equipment (UE2)) may be a subscriber of a first network (NW D) (e.g., a subscriber of NW D or PLMN D), or the UE may be roaming to a visited PLMN (PLMN D). Due to a disaster condition, the UE may be outside of RAN coverage of the NW D, but in the coverage of a second network (NW A). The NW A may not be in the UE's preferred list of PLMNs or the NW A may be in a list of forbidden PLMNs. The UE1 and UE2 may be registered with and use network D (e.g., PLMN D). The registration area (“RA”) of UE1 may include TA-x, TA-y and TA-z. The UE1, which may be in a connected state or an idle state, may be outside of the DisaC area. The UE2's RA may not include any of the TAs impacted by the disaster condition.

In some embodiments, UEs, which are registered with NW D and experience an out-of-coverage situation, may attempt NW A discovery and selection for disaster roaming independent of a current location (e.g., even if the UEs are outside of TA-x and/or TA-y). Thus, even if UE2 experiences an out of coverage situation and there are no PLMNs from the preferred list, the UE2 may attempt PLMN A discovery. This may result in higher power consumption. Such discovery attempts for NW A selection may be avoided if the UE is not located in the vicinity of the disaster area. Furthermore, the access network of NW A may broadcast an indication for accessibility for disaster roamers in an area that is larger than the actual disaster area of NW D (e.g., the NW A's service area for disaster roamer may include an area overlapping with NW D's TA-z). This may result in situation where UEs located outside the DisaC and are out-of-coverage (e.g., entering a basement or lower parking lots) may start NW A discovery and selection and may register with NW A.

In various embodiments, UEs in NW D may be dynamically configured to minimize or optimize attempts to select PLMN A. In certain embodiments, PLMN A search time may be minimized.

In certain embodiments, UE1 is in the vicinity of a DisaC but still in the network coverage of NW D (e.g., PLMN D). In such embodiments, the UE1 may be configured with on-demand DisaC information to optimize a network selection procedure for NW A (e.g., PLMN A).

In various embodiments, all UEs registered with the NW D (e.g., subscribers of NW D or inbound roamers in NW D) are configured with a list of PLMNs to be used in a disaster condition. The list of PLMNs to be used in a disaster condition may include an NW A identifier (“ID”).

In one solution, a ‘list of PLMN(s) to be used in disaster condition’, which is configured in the UE (e.g., USIM or ME) may be enhanced with the information about the network priority, preferred access technologies (e.g., radio access technologies) and/or frequency bands for each PLMN in the list. For example, the ‘list of PLMN(s) to be used in disaster condition’ may include the following information: PLMN A1, priority=‘X’; RAT1=E-UTRA; FB=band-A, prio N; band-B, prio M; PLMN A2, priority=‘Y’; RAT1=NR; FB=band-nAA, prio N; band-nBB, prio M; PLMN A3, priority=‘Z’; [RAT1=NR, FB=band-nAA]; [RAT2=E-UTRA; FB=band-A, prio N; FB=band-B, prio M]. Alternatively, or in addition, the above list may include forbidden frequency bands.

The ‘list of PLMN(s) to be used in disaster condition’ information may be derived, for example, by an existing application function (e.g., steering of roaming application function (“SOR-AF”)) or a new AF (e.g., disaster roaming AF (“DR-AF”)) or a similar AF. The AF (e.g., DR-AF) provides this information to the UDM for configuration to the UEs registered in the HPLMN. The UDM sends the enhanced ‘list of PLMN(s) to be used in disaster condition’ to the UE (e.g., via the NW D). For inbound roaming UEs (e.g., UEs registered in V-PLMN), the V-PLMN's AF (e.g., DR-AF) may provide the enhanced ‘list of PLMN(s) to be used in disaster condition’ to the AMFs serving inbound roamers. The AMFs configure this information in the inbound roaming UEs.

In some embodiments, additional DisaC configuration information may be provided to selected UEs. In such embodiments: 1) an access and mobility management function (“AMF”) may be able to determine that DisaC has happened and the corresponding disaster configuration information may be provided to UEs; 2) the AMF may determine which UEs are subject to an on-demand DisaC configuration and the AMF may provide the DisaC configuration information to these UEs; and/or 3) the UE receives, stores, and applies the DisaC configuration information for network selection to discover a suitable network for camping (e.g., NW A, PLMN A).

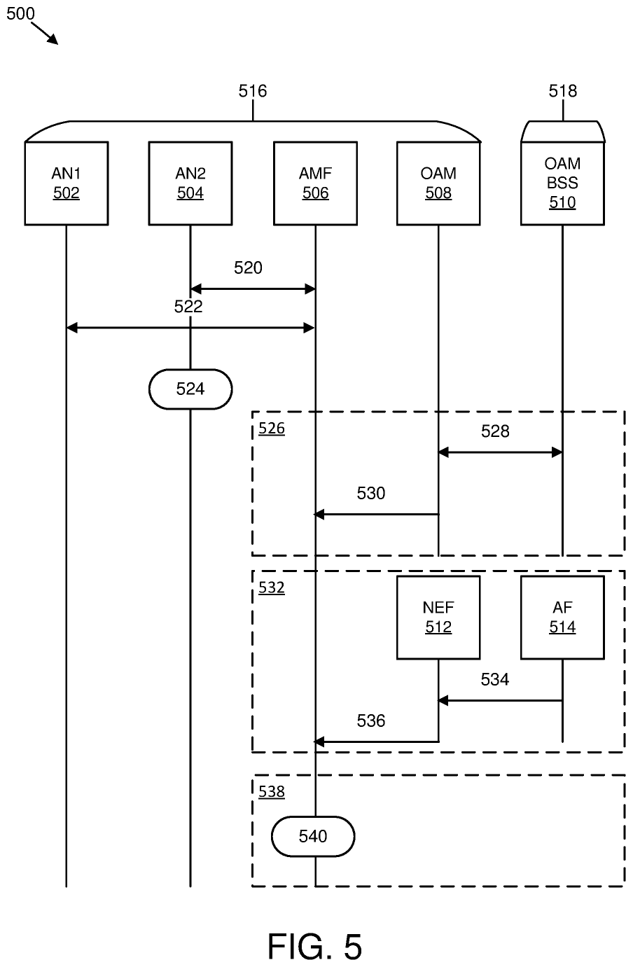

FIG. 5 is a schematic block diagram illustrating one embodiment of a system 500 for communicating to an AMF that a DisaC has occurred. The system 500 includes a first AN 502 (AN1), a second AN 504 (AN2), an AMF 506, an operations, administration, and management (“OAM”) 508 device, an OAM business support system (“BSS”) 510, a network exposure function (“NEF”) 512, and an application function (“AF”) 514. A first network 516 (NW D) may include the first AN 502, the second AN 504, the AMF 506, the OAM 508, the NEF 512, and the AF 514. Moreover, a second network 518 (NW A) may include the OAM and/or BSS 510. As may be appreciated, each of the communications in the system 500 may include one or more messages.

Specifically, FIG. 5 shows a procedure of how the AMF 506 becomes aware that a DisaC has happened and corresponding disaster configuration information.

In a first communication 520 and a second communication 522, AN functions (e.g., gNB, eNB, BS, non-3GPP interworking function (“N3IWF”)) and mobility management core network function (e.g., AMF) may establish a transport network layer association (“TNLA”). The AN nodes 502 and 504 inform the AMF 506 about at least the following parameters: a RAN node or AN identifier (“ID”) (e.g., global ID); TAIs served by the AN; single network slice selection assistance information (“NSSAI”) (“S-NSSAIs”) and so forth. The AMF 506 stores this information associated with the AN ID.

Due to a disaster condition, one access network element (e.g., AN2 504) fails 524 to operate. The TNLA with the AMF 506 fails. The link between AN2 504 and the OAM 508 system fails as well (e.g., the base station (“BS”) serving AN2 504 is not able to send keep-alive messages and to report performance indicators (e.g., key performance indicators (“KPIs”)) to the OAM 508 system.

In some embodiments, there may be a first set of steps 526 (e.g., alternative A) based on the OAM 508 system.

In a third communication 528, the OAM 508 system of NW D 516 may determine the failure of the AN2 504. For example, based on missing keep-alive messages, performance reports, or fault reports sent from the AN2 504 to the OAM 508. As another example, a fault management is a function provided by a PLMN network management system (“NMS”) and may be reused or enhanced for disaster condition detection. In various embodiments, ANI 502 may determine the failure of AN2 504 via X2 and/or Xn-interface monitoring solutions and AN1 502 may report the failure to the OAM 508 system. Considering further information (e.g., type of AN2 504 failure, or further information from an operations support system (“OSS”) and/or a BSS), or as configured by the operator, the OAM 508 system of NW D may conclude that the AN2 504 failure is due to disaster conditions. The OAM 508 system further determines which AMFs serve the area covered by AN2 504.

Further, based on pre-existing agreements with other networks (e.g., NW A 518), the OAM 508 system may determine the network (e.g., PLMN A) which may offer disaster roaming service (e.g., NW A 518). The NW D's 516 OAM 508 system may receive or may be configured with disaster roaming assistance information with regard to the NW A 518. For example, the NW D's 516 OAM 508 system may be configured with information about the preferred access technology types (e.g., ATs or RATs) and/or frequency bands (“FBs”) to be used in NW A 518. In addition, the NW D's 516 OAM 508 system may send the impacted geographical area of the disaster condition, so that the NW A 518 may configure its network correspondingly.

The NW D's 516 OAM 508 system determines disaster configuration information containing at least: the preferred access technology types (e.g., RATs) and/or FBs to be used by the UEs in the fallback network A; and/or the disaster area impacted by AN2 504 and corresponding AMFs.

In a fourth communication 530, based on the disaster roaming information determined in the third communication 528 and based on the geographic area of the disaster area, the OAM 508 system sends the disaster roaming configuration information to the AMFs (e.g., 506). In one example, the OAM 508 system may determine the AMFs to which the disaster information is to be sent, by considering the AMF region and AMF set information of the deployed AMFs. In another example, the OAM 508 system may configure disaster configuration information for all AMFs which serve a geographical area where the DisaC has happened (e.g., the AMFs having a serving area including the DisaC area). The OAM system may be aware about the serving area of each AMF. The disaster configuration information contains at least one of: 1) NW A 518 related information (e.g., disaster roaming assistance information): preferred ATs and/or FBs to be used in the NW A 518 and in other potential disaster roaming networks; and 2) NW D 516 related information about the disaster area (e.g., disaster detection assistance information): a) a list of AN IDs experiencing DisaC-if the AMF 506 receives the list of AN IDs experiencing DisaC, the AMF 506 applies mapping of the AN ID to the stored N2 TNLA information-accordingly, the AMF 506 may determine the list of TAIs served by the failed AN IDs (e.g., the list of TAIs where the DisaC applies); and b) a list of cell IDs close to the DisaC area (e.g., list of cell IDs neighboring the DisaC area and which are operating).

It should be noted that the OAM 508 system may need to be configured to be able to determine the list of cell IDs which are neighboring the DisaC area and which are still operating.

In various embodiments, there may be a second set of steps 532 (e.g., alternative B) based on AF and/or DR-AF triggered information.

In a fifth communication 534, the AF 514 or DR-AF may send DisaC configuration information to NW D 516. This is possible if the AF 514 or DR-AF can determine that DisaC has happened and determine the DisaC area. The AF 514 or DR-AF may determine to inform the NW D 516 about DisaC configuration information. The DisaC information may be sent from the AF 514 or DR-AF to: a) the NEF 512—the NEF 512 may discover all AMFs serving the target disaster area-in a sixth communication 536, the NEF 512 may send the disaster roaming configuration information to all discovered AMFs; or b) to the AMFs directly—the AF 514 or DR-AF may use NRF service to discover all appropriate AMFs serving the disaster area.

In certain embodiments, there may be a third set of steps 538 (e.g., alternative C) based on AMF 506 internal operations.

The AMF 506 is able to determine 540 locally the DisaC configuration information which includes at least one of the following information: 1) a list of tracking areas (e.g., tracking area (“TA”) identifiers, TAIs) where the disaster condition applies-for example, based on the failure of the TNLA with the access node and if the AMF 506 is aware that the failure is due to DisaC, the AMF 506 may determine the list of TAIs served by the failed AN IDs (e.g., the list of TAIs where the DisaC applies); 2) a list of cell IDs close to the DisaC area; and 3) preferred access types (e.g., RATs) and/or frequency bands per network offering disaster roaming services to the UE in DisaC area from NW D 516. Such information may be locally configured in the AMF 506.

As final result from FIG. 5, by using any of the alternatives A, B, C, or some combination thereof, the AMF 506 may determine and store at least one of the following elements of the DisaC configuration information: 1) disaster detection assistance information (e.g., NW D 516 related information about the disaster area such as the DisaC area) which may include: a) a list of tracking areas (e.g., TA identifiers, TAIs) where the disaster condition applies—the list of TAIs with DisaC may include one or more tracking areas; and/or b) a list of cell IDs close to the DisaC area—this list of cell IDs may include the cells which are around the DisaC area (e.g., the cells close to the cells which have failed); and 2) disaster roaming assistance information (e.g., NW A 518 related information to assist network selection for disaster roaming: preferred access types (e.g., AT and/or RATs) and/or FBs per network (e.g., NW A 518) offering disaster roaming services to the UE. This information may be either: A) independent from a “list of PLMNs to be used in disaster condition” (e.g., which may be pre-configured in the UE); or B) enhanced or updated “list of PLMNs to be used in disaster condition” which includes the preferred ATs, RATs, and/or FBs per PLMN—this may be similar to similar to a solution using an enhanced ‘list of PLMN(s) to be used in disaster condition’ information described herein-the FBs information may be used in the UE to apply these frequency bands if searching for appropriate cells in the NW A. Assuming that there are multiple FBs deployed by the NW A, the NW A may want to steer the disaster roaming UEs to a subset of the deployed FBs.

It should be noted that the benefit of the “disaster roaming assistance information” element of the DisaC configuration information is to allow to use the appropriate RAT and FB to quickly discover a cell in the NW A. This may avoid the need to re-direct the UE in NW A from an initial (e.g., not preferred) RAT or a cell and/or FB to another target (e.g., preferred) RAT or cell in NW A.

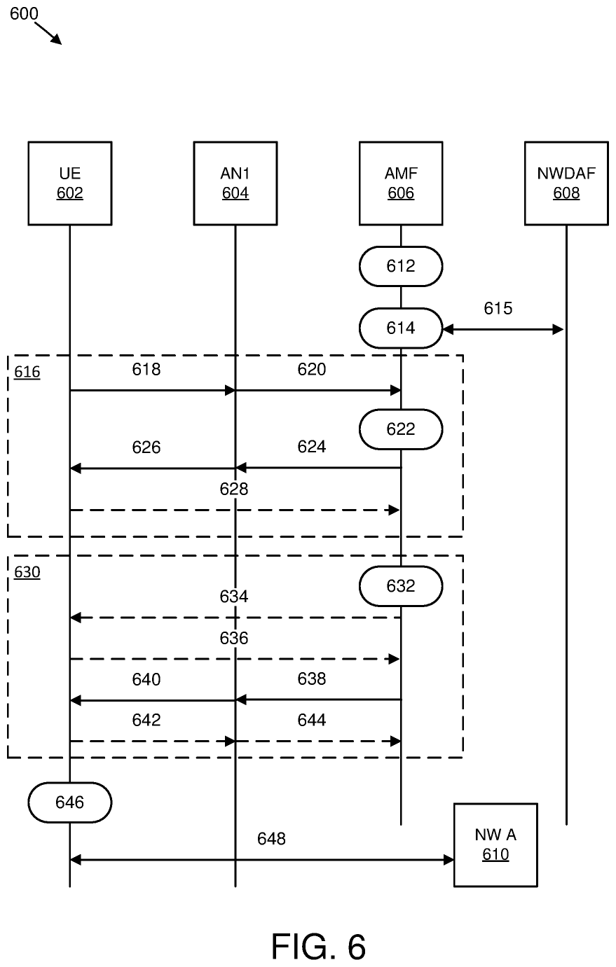

FIG. 6 is a schematic block diagram illustrating one embodiment of a system 600 for communicating configuration a UE with disaster configuration information. The system 600 includes a UE 602, a first AN 604 (ANI), an AMF 606, a network data analytics function (“NWDAF”) 608, and a NW A 610. As may be appreciated, each of the communications in the system 600 may include one or more messages.

Specifically, FIG. 6 shows how the AMF 606 determines which UEs are subject to on-demand DisaC configuration or update and how the AMF 606 provides the DisaC configuration information to these UEs.

The AMF 606 determines 612 the disaster configuration information as shown and described in relation to FIG. 5. In other words, the AMF 606 is aware of the disaster area information (e.g., list of TAs or list of cells where the disaster area applies) and/or the disaster roaming assistance information (e.g., preferred ATs and/or FBs per network offering disaster roaming services).

The AMF 606 determines 614 which UEs may (or should) be updated with DisaC configuration information. The UEs, which are to be updated, are UEs that are close to the disaster area and may enter the disaster area (e.g., mobile UEs moving in the direction of the disaster area). The AMF 606 may apply one of the following two options to determine the UEs to be updated.

In a first option and in a first communication 615, the AMF 606 requests analytics from the NWDAF 608 about the UE location and mobility. The AMF 606 may request UE mobility analytics from the NWDAF 608 for all UEs currently being served by the AMF 606.

The request to the NWDAF 608 may include the following: 1) analytic ID=“UE mobility analytics”; 2) target of analytics reporting: one or more UE IDs served by the AMF 606; 3) area of interest: the disaster area and a list of cell IDs, or a geographical area; and/or 4) analytics target period: the time period where analytics (e.g., predictions) are requested.

The NWDAF 608 sends a report to the subscribed AMFs including the UEs that are expected to enter the disaster area.

In some embodiments, a new NWDAF mobility analytics (e.g., “location prediction analytics”) may be used. The new NWDAF mobility analytics may provide an indication of a list of UEs that are expected to be in a specific area (e.g., a disaster area). The advantage of this may be that the AMF 606 may not require to identify which UEs to request analytics. Instead, the AMF 606 requests, from the NWDAF 608, location prediction analytics including in the request an area of interest equal to the disaster area.

The AMF 606 may discover the NWDAF 608 which provides this NWDAF mobility analytics and may subscribe with the NWDAF 608. The following example shows possible attributes for the NWDAF mobility analytics: {Input: [Target UE=any UE; Area of interest=disaster area; Target period=next X hours]; Output: [List of UEs expected to visit the disaster area the next X hours]}.

In a second option, the AMF 606 determines locally (e.g., internally) which UEs are subject to update with DisaC configuration information. For example, the AMF 606 may consider the current location of the UEs with respect to how close the UEs are to the disaster area boundary, or the AMF 606 may estimate the future locations (e.g., trajectory) of the UEs based on the moving pattern (e.g., considering the history of UEs locations).

In some embodiments, there may be a first set of steps 616 (e.g., alternative A) for UEs performing a registration procedure due to mobility.

In a second communication 618 and a third communication 620, the UE 602 sends a registration request (e.g., non-access stratum (“NAS”) registration request) to the network due to mobility or other events triggered at the UE-side.

The AMF 606 determines 622 that the UE 602 is close or in the surroundings of the disaster area (e.g., DisaC area). For example, the AMF 606 determines that the UE's 602 registration area (e.g., including a TAI list) includes at least one TAI where a DisaC applies. In certain embodiments, the AMF 606 may use the NWDAF 608 mobility analytics or “location prediction analytics” provided by the NWDAF 608. For example, if the UE's 602 RA includes at least TA-x or TA-y, the AMF 606 decides to include the DisaC configuration information for providing to the UE.

In a fourth communication 624 and a fifth communication 626, the AMF 606 sends an NAS registration accept message to the UE 602. The message may contain the DisaC configuration information as described in FIG. 5. The DisaC configuration information may contain at least one of: 1) disaster roaming assistance information (e.g., information to steer the UE 602 to fallback networks such as NW A): a) an existing or enhanced list of PLMNs to be used in a disaster condition (e.g., only a list of PLMNs); and/or b) operator controlled PLMN selector with access technology for disaster roaming, which includes a PLMN ID and the corresponding information of ATs and/or FBs to be used; and 2) disaster detection assistance information (e.g., NW D related information about the DisaC area): a list of TAIs impacted by the DisaC or a list of cell IDs close to the DisaC area. The DisaC configuration information may enhance the “list of PLMNs to be used in disaster condition” (e.g., associating each PLMN with the “preferred ATs and/or FBs” as received in the DisaC configuration information).

In an optional seventh communication 628, the UE 602 may transmit a response to the NAS registration accept message to the AMF 606.

In various embodiments, there may be a second set of steps 630 (e.g., alternative B) for UEs already registered with the AMF 606 and having an RA including at least a part of the DisaC area.

The AMF 606 may determine 632 that UEs in a connection management (“CM”) connected (“CM-connected”) state and/or UEs in a connection management (“CM”) idle (“CM-Idle”) state may need to be updated with DisaC configuration information. For example, the AMF 608 may inspect the mobility context of the registered UEs (e.g., the UE location history information and/or current registration area including list of TAs) and the AMF 608 may select those UEs whose registration area contains at least one TA impacted by the DisaC (e.g., TA-x and/or TA-y). The AMF 606 may determine to perform a UE configuration update (“UCU”) procedure to update these UEs with the DisaC configuration information.

In an optional eighth communication 634 and an optional ninth communication 636, the AMF 606 may perform a core network initiated paging procedure for the UEs determined in step 632. The paging may be required to reach the UEs in the CM-Idle state.

In a tenth communication 638 and an eleventh communication 640, the AMF 606 performs a UCU procedure. The AMF 606 may send a UCU command message to the UE 602 containing the DisaC configuration information (e.g., disaster detection assistance information and/or disaster roaming assistance information) as described in FIG. 5.

In an optional twelfth communication 642 and an optional thirteenth communication 644, the UE 602 may send an NAS UCU complete message to acknowledge the successful reception of the NAS UCU command message.

The UE 602 determines 646 whether to apply the disaster roaming by using the DisaC configuration information. The UE 602 may apply 2 phases of detection: 1) the UE 602 uses the disaster detection assistance information (e.g., NW D related information) from the DisaC configuration information (e.g., a list of TAIs impacted by the DisaC or a list of cell IDs close to the DisaC area) to determine whether disaster roaming may apply if a coverage in NW D is lost—for example, if the UE 602 loses cell coverage and the UE 602 determines whether the last cell used by the UE 602 was in the list of TAIs impacted by the DisaC or the a list of cell IDs close to the DisaC area—if yes, the UE 602 determines that the DisaC may apply; and 2) the UE 602 uses the disaster roaming assistance information (e.g., NW A related information) from the DisaC configuration information (e.g., preferred ATs and/or FBs associated with a network) together with the “list of PLMNs to be used in disaster condition” which may have been configured by NW D in the UE 602 or in the universal subscriber identity module (“USIM”)—as a result, the UE 602 constructs internally a kind of enhanced list of “operator controlled PLMN selector with access technology and frequency band for disaster roaming”; or the enhanced list is sent by the network (e.g., AMF 604). The UE 602 uses the configured FBs information when searching for appropriate cells for camping in the NW A. The UE 602 may first search for a suitable cell for camping, from where to start the registration procedure with NW A, in the FBs configured in the disaster roaming assistance information.

If the UE 602 determines that a disaster may have occurred in the current registered network or PLMN (e.g., by using the disaster detection assistance information (NW D related information from the DisaC configuration information)), the UE 602 may apply the disaster roaming assistance information (e.g., NW A related information from the DisaC configuration information).

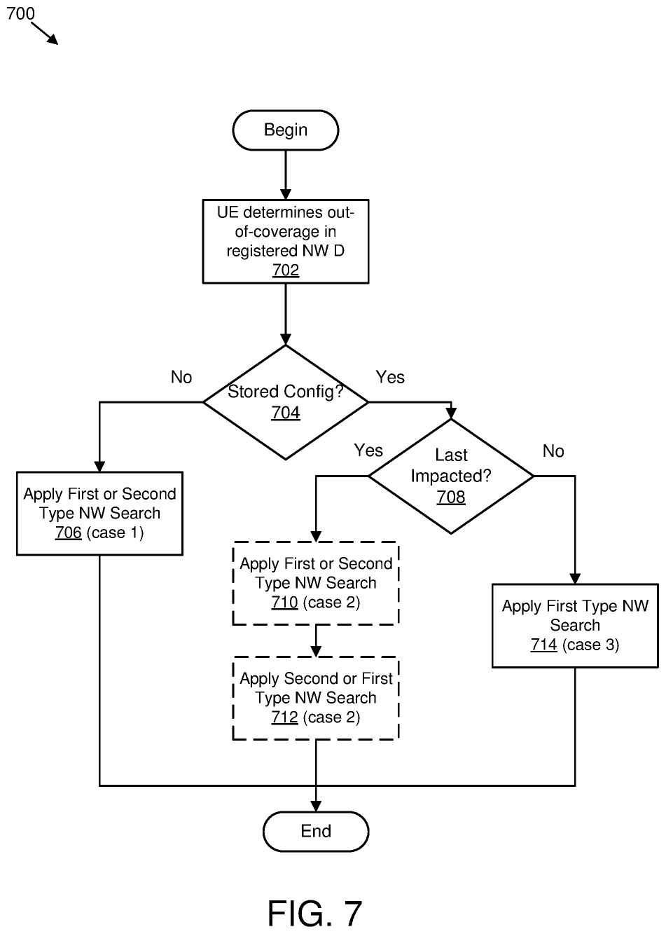

In a fourteenth communication 648, the UE 602 selects and registers with NW A 610. For example, the UE selects NW A from a list of forbidden networks only if NW A's system information block (“SIB”) indicates that it provides disaster roaming services for UEs from PLMN D. If the network NW A is not in the list of forbidden networks, the UE 602 may select NW A without a SIB indicating that it provides disaster roaming services for UEs from PLMN D. One embodiment of internal processing in the UE 602 is shown in FIG. 7.

In some embodiments, after the UE 602 has discovered NW A and a suitable cell, the UE 602 initiates a NAS registration procedure with NW A for disaster roaming registration. The NW A determines that the UE 602 is inbound disaster roamer (e.g., based on a specific indication in the registration request message) and may determine a registration area (“RA”) for the UE which includes TAs that may overlap with the area of the disaster area in NW D. The AMF in NW A should have been received or configured with the disaster serving area either by the OAM system in NW A, or by the UE's 602 UDM in NW D.

For this purpose, in one alternative, the UDM in NW D may be configured (e.g., via NW D OAM system) with the corresponding disaster area (e.g., geographical area). If the AMF in NW A requests the UE 602 subscription data from UDM, the AMF may also provide an indication that this is disaster roaming registration, then the UDM may send the disaster area information (e.g., geographical area) in addition to other subscription data to the AMF in NW A. The AMF in NW A uses the disaster area information (e.g., geographical area) to derive the registration area (e.g., list of tracking areas in NW A) for the UE 602 to possibly overlap with the disaster area (e.g., geographical area).

The AMF in NW A may also derive a mobility restrictions list (e.g., UE 602 service area restrictions like list of TAIs) for the UE 602. The AMF may send the mobility restrictions to the RAN.

In one embodiment, during the registration procedure, the following steps may apply: a) while the AMF requests access and mobility policies (e.g., AM policies) from the policy control function (e.g., PCF or AM-PCF) for the UE 602, the AMF may include an indication that the UE 602 is a disaster inbound roamer and the AMF may include the NW ID (e.g., NW D, PLMN D) from the network where the UE 602 has experienced a disaster condition; b) the AMF may select a dedicated PCF for inbound disaster roamers (e.g., the AMF may use a local configuration or the AMF may use network repository function (“NRF”) services if a new input parameter (e.g., disaster inbound roamer) for NF selection (e.g., PCF selection) is used); c) the PCF uses A) the indication from the AMF that the UE 602 is a disaster inbound roamer (and optionally the NW D ID) and B) based on local configuration in the PCF (e.g., policies to be applied to disaster inbound roamers, and/or also considering the NW ID of the network experiencing disaster condition), the PCF may derive a RAT frequency selection priority (“RFSP”) index specific for inbound disaster roamers, in particular roamers from NW D. The RFSP index may include specific RATs or frequency bands which may be preferred for the disaster inbound roamer; d) the RFSP index is sent from the PCF to the AMF, the AMF stores the RFPS index in the UE's context and AMF forwards it to the RAN together with the UE 602 context (e.g., upon transfer from idle to connected state); and e) the RAN configures the UE 602 with the preferred RATs or FBs using RRC signalling. It should be noted that the preferred RATs and/or FBs in the RFSP index may be different from the RATs and/or FB which may be configured by the AMF in NW D.

FIG. 7 is a flow chart diagram illustrating one embodiment of a method 700 for a UE performing network selection. Specifically, FIG. 7 shows the flow diagram of a UE method of how to apply the DisaC configuration information. It should be noted that the DisaC configuration information is sent on-demand to the UEs which the registered network or registered PLMN (e.g., AMF) has determined to update. In other words, the DisaC configuration information is different from, but complementary to, the “list of PLMNs to be used in disaster condition” which may be configured to all UEs currently registered with a NW D. However, the DisaC configuration information may enhance the “list of PLMNs to be used in disaster condition” (e.g., associating each PLMN with preferred ATs and/or FBs as received in the DisaC configuration information).

In certain embodiments, the FIG. 7 uses the term “list of preferred PLMNs” (e.g., which may also include non-public network) which includes at least one of: 1) home PLMN (“HPLMN”) selector with access technology; 2) equivalent HPLMN list; 3) operator controlled PLMN selector with access technology; and/or 4) user controlled PLMN selector with access technology.

FIG. 7 starts with the UE determining 702 that the UE is out-of-coverage in a registered network (e.g., NW D or registered PLMN). The process of out-of-coverage detection may be radio link failure (“RLF”) detection in the AS layer (e.g., using timers such as T310 and T311). After detection of out-of-coverage, the UE performs the internal check to determine 704 whether the “disaster detection assistance information” element of DisaC configuration information is stored. If it is not stored, the UE performs 706 case 1 as described herein. If it is stored, the UE performs the check to determine 708 whether the last cell was a part of list of TAs or list of cells included in the “disaster detection assistance information.” Depending on the outcome of this check, the UE may perform case 2 with steps 710 and/or 712, or case 3 with step 714 as described herein.

In case 1 (e.g., the “disaster detection assistance information” element of the DisaC configuration information is not configured in the UE), upon loss of network coverage the UE may try to find other networks from the “list of preferred PLMNs.” After none of the “list of preferred PLMNs” can be discovered, the UE may conclude that the disaster condition may have happened and the UE may apply where the list of PLMNs to be used in disaster condition and the “disaster roaming assistance information” element of the DisaC configuration information (e.g., if the latter is available in the UE).

In case 2 (e.g., the “disaster detection assistance information” element of the DisaC configuration information is stored in the UE and the last cell was part of the list of TAs impacted by the DisaC), the UE may conclude that the loss of coverage is due to a disaster condition. Consecutively, the UE may consider to apply: 1) alternative A (step 710): first the “list of preferred PLMNs” for network selection—after none of the “list of preferred PLMNs” can be discovered, the UE may apply the list of PLMNs to be used in a disaster condition and the “disaster roaming assistance information” element of the DisaC configuration information (e.g., if the latter is available in the UE); or 2) alternative B (step 712): first the list of PLMNs to be used in disaster condition including the preferred RATs and/or FBs for network selection and then “list of preferred PLMNs.”—may be used if the UE is aware about the “list of cell IDs close to the DisaC area” as described in FIG. 5.

In case 3 (e.g., the DisaC configuration information is available and the last cell was not part of the list of TAs impacted by the DisaC), the UE may conclude that the lost-of-coverage is not due to disaster condition. The UE may apply the “list of preferred PLMNs” for network selection. In other words, the UE may ignore the “list of PLMNs to be used in disaster condition.”

Various embodiments described herein may have a benefit of the UE having the opportunity to determine whether a disaster condition applies (e.g., by applying the “disaster detection assistance information”). For case 3, the UE does not need to perform any procedures relevant to disaster roaming. In addition, in certain embodiments, the UE is able to determine that the loss of coverage is due to a disaster condition in case 2 and the UE may apply alternative B which allows quicker selection of serving network (e.g., NW A) in a disaster condition. The quicker re-gaining of connectivity to the UE may be important in disaster conditions so that the user of the UE may quickly use communication services. Furthermore, in some embodiments, such as in any of the cases 1, 2 or 3, the UE may apply the “disaster roaming assistance information” element of the DisaC configuration information which enables to use an appropriate RAT and FB to discover a cell in a NW A.

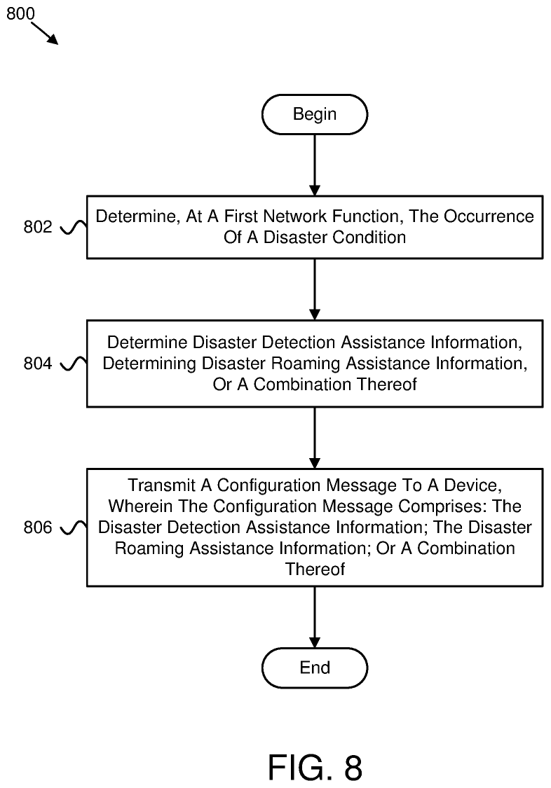

FIG. 8 is a flow chart diagram illustrating one embodiment of a method 800 for configuring disaster assistance information. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes determining 802, at a first network function, the occurrence of a disaster condition. In some embodiments, the method 800 includes determining 804 disaster detection assistance information, determining disaster roaming assistance information, or a combination thereof. In certain embodiments, the method 800 includes transmitting 806 a configuration message to a device. The configuration message includes: the disaster detection assistance information; the disaster roaming assistance information; or a combination thereof.

In certain embodiments, determining the occurrence of the disaster condition comprises: receiving information from an operating system, wherein the operating system comprises an operations, administration, and maintenance system; receiving information from an application function; receiving mobility analytics, wherein receiving the mobility analytics comprises receiving the mobility analytics from a network data analytics function; or some combination thereof. In some embodiments, the method 800 further comprises determining a set of user equipments to be updated with the disaster detection assistance information, the disaster roaming assistance information, or the combination thereof.

In various embodiments, the method 800 further comprises receiving information indicating the set of user equipments from a network data analytics function. In one embodiment, the first network function comprises an access and mobility management function. In certain embodiments, the device comprises a user equipment.

In some embodiments, the disaster detection assistance information comprises: a list of tracking areas impacted by the disaster condition; a list of cells proximate to the disaster condition; or a combination thereof. In various embodiments, the disaster roaming assistance information comprises: a network identifier for a network offering disaster roaming; a preferred access type for the network offering disaster roaming; a frequency band for the network offering disaster roaming; or some combination thereof.

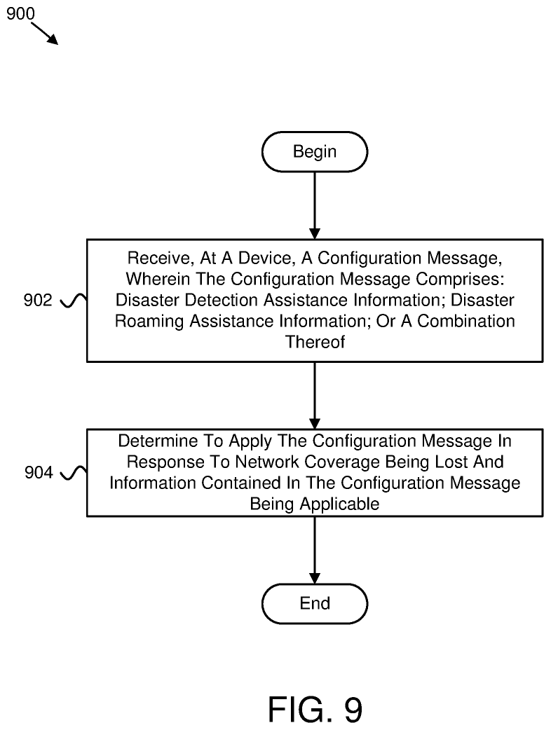

FIG. 9 is a flow chart diagram illustrating one embodiment of a method 900 for configuring disaster assistance information. In some embodiments, the method 900 is performed by an apparatus, such as the remote unit 102. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, at a device, a configuration message. The configuration message includes: disaster detection assistance information; disaster roaming assistance information; or a combination thereof. In some embodiments, the method 900 includes determining 904 to apply the configuration message in response to network coverage being lost and information contained in the configuration message being applicable.

In certain embodiments, receiving the configuration message comprises receiving the configuration message from a first network function. In some embodiments, the first network function comprises an access and mobility management function. In various embodiments, the device comprises a user equipment.

In one embodiment, the disaster detection assistance information comprises: a list of tracking areas impacted by the disaster condition; a list of cells proximate to the disaster condition; or a combination thereof. In certain embodiments, the disaster roaming assistance information comprises: a network identifier for a network offering disaster roaming; a preferred access type for the network offering disaster roaming; a frequency band for the network offering disaster roaming; or some combination thereof.

In one embodiment, a method comprises: determining, at a first network function, the occurrence of a disaster condition; determining disaster detection assistance information, determining disaster roaming assistance information, or a combination thereof; transmitting a configuration message to a device, wherein the configuration message comprises: the disaster detection assistance information; the disaster roaming assistance information; or a combination thereof.

In certain embodiments, determining the occurrence of the disaster condition comprises: receiving information from an operating system, wherein the operating system comprises an operations, administration, and maintenance system; receiving information from an application function; receiving mobility analytics, wherein receiving the mobility analytics comprises receiving the mobility analytics from a network data analytics function; or some combination thereof.

In some embodiments, the method further comprises determining a set of user equipments to be updated with the disaster detection assistance information, the disaster roaming assistance information, or the combination thereof.

In various embodiments, the method further comprises receiving information indicating the set of user equipments from a network data analytics function.

In one embodiment, the first network function comprises an access and mobility management function.

In certain embodiments, the device comprises a user equipment.

In some embodiments, the disaster detection assistance information comprises: a list of tracking areas impacted by the disaster condition; a list of cells proximate to the disaster condition; or a combination thereof.

In various embodiments, the disaster roaming assistance information comprises: a network identifier for a network offering disaster roaming; a preferred access type for the network offering disaster roaming; a frequency band for the network offering disaster roaming; or some combination thereof.

In one embodiment, an apparatus comprises a first network function. The apparatus further comprises: a processor that: determines the occurrence of a disaster condition; determines disaster detection assistance information, determines disaster roaming assistance information, or a combination thereof; and a transmitter that transmits a configuration message to a device, wherein the configuration message comprises: the disaster detection assistance information; the disaster roaming assistance information; or a combination thereof.

In certain embodiments, the apparatus further comprises a receiver, wherein the processor determining the occurrence of the disaster condition comprises the receiver: receiving information from an operating system, wherein the operating system comprises an operations, administration, and maintenance system; receiving information from an application function; receiving mobility analytics, wherein receiving the mobility analytics comprises receiving the mobility analytics from a network data analytics function; or some combination thereof.

In some embodiments, the processor determines a set of user equipments to be updated with the disaster detection assistance information, the disaster roaming assistance information, or the combination thereof.

In various embodiments, the apparatus further comprises a receiver that receives information indicating the set of user equipments from a network data analytics function.

In one embodiment, the first network function comprises an access and mobility management function.

In certain embodiments, the device comprises a user equipment.

In some embodiments, the disaster detection assistance information comprises: a list of tracking areas impacted by the disaster condition; a list of cells proximate to the disaster condition; or a combination thereof.

In various embodiments, the disaster roaming assistance information comprises: a network identifier for a network offering disaster roaming; a preferred access type for the network offering disaster roaming; a frequency band for the network offering disaster roaming; or some combination thereof.

In one embodiment, a method comprises: receiving, at a device, a configuration message, wherein the configuration message comprises: disaster detection assistance information; disaster roaming assistance information; or a combination thereof; and determining to apply the configuration message in response to network coverage being lost and information contained in the configuration message being applicable.

In certain embodiments, receiving the configuration message comprises receiving the configuration message from a first network function.

In some embodiments, the first network function comprises an access and mobility management function.

In various embodiments, the device comprises a user equipment.

In one embodiment, the disaster detection assistance information comprises: a list of tracking areas impacted by the disaster condition; a list of cells proximate to the disaster condition; or a combination thereof.

In certain embodiments, the disaster roaming assistance information comprises: a network identifier for a network offering disaster roaming; a preferred access type for the network offering disaster roaming; a frequency band for the network offering disaster roaming; or some combination thereof.

In one embodiment, an apparatus comprises a device. The apparatus further comprises: a receiver that receives a configuration message, wherein the configuration message comprises: disaster detection assistance information; disaster roaming assistance information; or a combination thereof; and a processor that determines to apply the configuration message in response to network coverage being lost and information contained in the configuration message being applicable.

In certain embodiments, the receiver receiving the configuration message comprises the receiver receiving the configuration message from a first network function.

In some embodiments, the first network function comprises an access and mobility management function.

In various embodiments, the device comprises a user equipment.

In one embodiment, the disaster detection assistance information comprises: a list of tracking areas impacted by the disaster condition; a list of cells proximate to the disaster condition; or a combination thereof.

In certain embodiments, the disaster roaming assistance information comprises: a network identifier for a network offering disaster roaming; a preferred access type for the network offering disaster roaming; a frequency band for the network offering disaster roaming; or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A first network function, comprising:
at least one memory; and
at least one processor coupled with the at least one memory and configured to cause the first network function to:
receive a registration request message from a user equipment (UE), wherein the registration request message comprises an indication for disaster roaming registration;
determine, based on the indication, that the registration request message is associated with the disaster roaming registration;
transmit, to a second network function, a request for UE subscription data, wherein the request comprises an indication for a disaster roaming service; and
receive, from the second network function, a response comprising subscription data for the disaster roaming service.

17. The first network function of claim 16, wherein the first network function comprises an access and mobility management function (AMF).

18. The first network function of claim 16, wherein the second network function comprises a unified data management (UDM).

19. The first network function of claim 16, wherein the at least one processor is configured to cause the first network function to determine a UE registration area.

20. The first network function of claim 19, wherein the UE registration area comprises an area with a disaster condition.

21. The first network function of claim 19, wherein the UE registration area is determined based on the subscription data for the disaster roaming service.

22. The first network function of claim 19, wherein the at least one processor is configured to cause the first network function to transmit the UE registration area to the UE.

23. A method performed by a first network function, the method comprising:
receiving a registration request message from a user equipment (UE), wherein the registration request message comprises an indication for disaster roaming registration;
determining, based on the indication, that the registration request message is associated with the disaster roaming registration;
transmitting, to a second network function, a request for UE subscription data, wherein the request comprises an indication for a disaster roaming service; and
receiving, from the second network function, a response comprising subscription data for the disaster roaming service.

24. The method of claim 23, wherein the first network function comprises an access and mobility management function (AMF).

25. The method of claim 23, wherein the second network function comprises a unified data management (UDM).

26. The method of claim 23, further comprising determining a UE registration area.

27. The method of claim 26, wherein the UE registration area comprises an area with a disaster condition.

28. The method of claim 26, wherein the UE registration area is determined based on the subscription data for the disaster roaming service.

29. The method of claim 26, further comprising transmitting the UE registration area to the UE.

30. A user equipment (UE), comprising:
at least one memory; and
at least one processor coupled with the at least one memory and configured to cause the UE to:
transmit a registration request message to a network function, wherein the registration request message comprises an indication for disaster roaming registration; and
receive a UE registration area from the network function, wherein the UE registration area is associated with the disaster roaming registration.

31. The UE of claim 30, wherein the network function comprises an access and mobility management function (AMF).

32. The UE of claim 30, wherein the UE registration area comprises an area with a disaster condition.

33. The UE of claim 30, wherein the UE registration area is determined based on subscription data for a disaster roaming service associated with the disaster roaming registration.

34. A processor for wireless communication, comprising:
at least one controller coupled with at least one memory and configured to cause the processor to:
transmit a registration request message to a network function, wherein the registration request message comprises an indication for disaster roaming registration; and
receive a UE registration area from the network function, wherein the UE registration area is associated with the disaster roaming registration.

35. The processor of claim 34, wherein the UE registration area comprises an area with a disaster condition.
